(19) United States
(12) Patent Application Publication
(10) Pub. No.: US 2019/0248315 A1
(43) Pub. Date: Aug. 15, 2019

(54) PRE-COLLISION SYSTEM AND CORRESPONDING OCCUPANT PROTECTION SYSTEM FOR A VEHICLE

(71) Applicant: Robert Bosch GmbH, Stuttgart (DE)

(72) Inventors: Florian Oesterle, Stuttgart (DE); Gian Antonio D' Addetta, Stuttgart (DE); Heiko Freienstein, Weil Der Stadt (DE); Henning Hoepfner, Renningen (DE); Josef Kolatschek, Weil Der Stadt (DE)

(21) Appl. No.: 16/318,623

(22) PCT Filed: Jun. 20, 2017
(86) PCT No.: PCT/EP2017/065029

§ 371 Date: Jan. 17, 2019

(30) Foreign Application Priority Data
Jul. 18, 2016 (DE) 102016213071.4

(51) Int. Cl. B60R 21/0134; B60R 22/48; B60R 22/46; B60W 50/00; B60W 30/08

(52) U.S. Cl. CPC B60R 21/0134; B60R 22/48; B60R 22/46; B60Y 2400/30; B60W 50/0098; B60W 30/08; B60R 2022/4841; B60W 50/0097

(57) ABSTRACT

A pre-collision system for an occupant protection system of a vehicle, includes a predictive sensor system, a vehicle seat, a restraint system, and an evaluation and control unit that evaluates output signals of the predictive sensor system and activates a belt tensioning function of the restraint system if the evaluation of the output signals indicates an imminent collision, where the belt tensioning function generates a tensile force in the belt, which presses a corresponding occupant into the vehicle seat, with a resulting kinetic energy of the occupant that releases a pre-trigger mechanism, which is integrated into a mounting of the vehicle seat, and that enables a blocked degree of freedom of the vehicle seat so that the entire vehicle seat tilts about a defined tilt axis in the direction of an expected impact force.

### CROSS-REFERENCE TO RELATED APPLICATIONS

The present application is the national stage of International Pat. App. No. PCT/EP2017/065029 filed Jun. 20, 2017, and claims priority under 35 U.S.C. § 119 to DE 10 2016 213 071.4, filed in the Federal Republic of Germany on Jul. 18, 2016, the content of each of which are incorporated herein by reference in their entireties.

### FIELD OF THE INVENTION

The present invention relates to a pre-collision system for an occupant protection system of a vehicle, as well as to an occupant protection system for a vehicle, having such a pre-collision system.

### BACKGROUND

Occupant protection systems that utilize a predictive sensor system or surround sensor system are known from the related art. Sensors, such as radar, ultrasonic or video sensors, for monitoring the surroundings of a vehicle, are used for functions of driver assistance systems and/or occupant protection systems, such as AEB (automatic emergency braking systems). In this context, the object is to acquire environmental data, such as critical objects on a collision course, which are relevant to the specific function. In particular, the optimum conditioning of non-ideal sensor signals is becoming increasing important for reliably detecting and classifying objects in the environment of the vehicle. Currently, further sensor technologies, such as lidar systems, are beginning to be considered and are being developed for future, partially, highly and/or fully automatic driving functions.

At the interface of active and passive safety, so-called pre-crash functions utilize the active safety sensors for monitoring the surroundings, in order to detect a possible collision with a relevant object in a critical situation. In the case of an inevitable collision, on one hand, the activation thresholds of a corresponding air bag control unit can be lowered, in order to optimize the reliability and the robustness of the decision to trigger restraint systems. In addition, reversible “pre-fire functions” for, e.g., controlling a reversible belt tensioner, and/or irreversible “pre-trigger functions” for, e.g., controlling various air bags, adaptive crash structures, pyrotechnically actuated belts, etc., can also be activated as restraining devices for passive safety, in order to lessen the consequences of a collision for the vehicle occupants.

DE 103 45 726 B4 describes, for example, a restraint system for restraining an occupant in a motor vehicle, including a seat belt, to which a force is applied by a belt tensioner connectible to a control unit; at least one vehicle situation detection device for dynamically detecting vehicle situations, the vehicle situation detection device being connectible to the control unit for transmitting the acquired data to the same; and at least one occupant parameter determination device for dynamically acquiring occupant parameter data, the occupant parameter determination device being connectible to the control unit for transmitting the acquired data to it. In a collision phase, the control unit calculates, from the acquired data of the vehicle situation detection device and/or the occupant parameter determination device, the survival space between the occupant and any object the occupant can strike, and correspondingly controls the force of the belt tensioner dynamically for optimum utilization of the survival space in the motor vehicle.

### SUMMARY

A pre-collision system for an occupant protection system of a vehicle and/or a corresponding occupant protection system for a vehicle, including such a pre-collision system, according to example embodiments of the present invention, have an advantage that a pre-collision system, which provides a lengthened rearward displacement path prior to contact or a collision, can be implemented by expanding a belt tensioning function of a conventional belt system in a simple and cost-effective manner.

Example embodiments of the present invention provide a pre-collision system for an occupant protection system of a vehicle, including a vehicle seat, an evaluation and control unit, and a restraint system. The evaluation and control unit evaluates output signals of the predictive sensor system and activates a belt tensioning function of the restraint system if the evaluation of the output signals indicates an imminent collision. In the belt, the belt tensioning function generates a tensile force, which presses a corresponding occupant into the vehicle seat. In this connection, a kinetic energy or movement of the occupant resulting from the belt tensioning function releases a pre-trigger mechanism, which is integrated into a mounting of the vehicle seat and restores a blocked degree of freedom of the vehicle seat, so that the entire vehicle seat tilts about a defined tilt axis, in the direction of an expected impact force.

According to an example embodiment, an occupant protection system for a vehicle includes a predictive sensor system, a vehicle seat, an evaluation and control unit, a restraint system, and a pre-collision system. In this connection, the evaluation and control unit evaluates output signals of the predictive sensor system and activates a belt tensioning function of the restraint system if the evaluation of the output signals indicates an imminent crash. In the belt, the belt tensioning function generates a tensile force that presses a corresponding occupant into the vehicle seat.

In the case of a head-on collision, example embodiments of the pre-collision system for an occupant protection system of a vehicle reduce the kinetic energy of the occupant on the available restraint path, the so-called ride-down space. If it is possible to successfully give the occupant a preliminary impulse prior to the effect of the impact, then the restraining force can be reduced during the deceleration event. Using the pre-collision protection system having the pre-trigger mechanism, both the restraining path can be increased and the kinetic energy of the occupant can be decreased, which means that the effective restraining force can be reduced in an advantageous manner.

If the belt tensioning function is activated, the occupant rotates with the vehicle seat about the tilt axis, in the direction of the expected impact force, which means that an additional distance and a velocity are generated, which have a positive effect on the loading values of the occupant, since the restraining force can be reduced accordingly. In this connection, the impact force is the force, which acts upon the vehicle due to the collision and causes the vehicle to decelerate. In the frame of reference of the vehicle, an accelerated movement of the occupant is directed oppositely to this force. In addition, the increased inclination of the seat surface counteracts an anti-submarining effect, which relates to unwanted slipping of the occupant under a waist belt. The movement of the occupant and of the vehicle seat advantageously does not require an additional actuator, but is driven via the belt tensioning function alone and activated by the resulting kinetic energy of the occupant moved on the vehicle seat, i.e., of his/her movement.

Presently, the evaluation and control unit can be understood as an electrical device, such as a control unit, in particular, an air bag control unit, which processes and/or evaluates acquired sensor signals. The evaluation and control unit can include at least one interface, which can take the form of hardware and/or software. In a hardware design, the interfaces can, for example, be part of a so-called system ASIC that includes many different functions of the evaluation and control unit. However, it is also possible for the interfaces to be separate integrated circuits or to be at least partially made up of discrete components. In a software design, the interfaces can be software modules that are present, for example, on a microcontroller, next to other software modules. A computer program product having program code, which is stored on a machine-readable medium, such as a solid-state memory, a hard-disk memory or an optical memory, and is used to perform the evaluation when the program is executed by the evaluation and control unit, is also advantageous.

A sensor system or sensor unit is understood as a unit that includes at least one sensor element that measures a physical variable and/or a change in a physical variable directly or indirectly and preferably converts it to an electrical sensor signal. This can be accomplished, for example, by transmitting and/or receiving sonic waves and/or electromagnetic waves, and/or using a magnetic field and/or the change in a magnetic field, and/or by receiving satellite signals, for example, a GPS signal.

Optical sensor elements that include, for example, a photographic plate and/or a fluorescing surface and/or a semiconductor, which detect the incidence and/or the intensity, the wavelength, the frequency, the angle, etc., of the received wave, such as infrared sensor elements, can be used. An acoustic sensor element, such as an ultrasonic sensor element and/or a high-frequency sensor element and/or a radar sensor element, and/or a sensor element, which reacts to a magnetic field, such as a Hall sensor element, and/or a magnetoresistive sensor element and/or an inductive sensor element, which records the change in a magnetic field, e.g., via the voltage generated by magnetic induction, is/are also usable. The sensor signals can be determined statically and/or dynamically. In addition, the sensor signals can be determined continually or one time.

The detected sensor signals are evaluated and converted to sensor data by the evaluation and control unit, the sensor data including a physical variable measured by the specific sensor unit. In this connection, for example, the path change in a specific time window is ascertained by a sensor element, and a speed and/or acceleration is calculated from this by the evaluation and control unit. Further physical variables capable of being calculated include mass, revolutions per unit time, force, energy, and/or other conceivable variables, such as a probability of occurrence of a particular event.

It is particularly advantageous that the pre-trigger mechanism include at least one hinged bearing on which the vehicle seat can be supported so as to be tiltable about the tilt axis. In addition, the pre-trigger mechanism can include at least one rail piece having a guide opening, in which a mounting element of the vehicle seat can be guided between a starting position assumed during normal operation and an end position assumed prior to impact. Preferably, the at least one hinged bearing and the at least one rail piece can be positioned in a seat rail so as to be able to move longitudinally. Thus, for example, the vehicle seat can have, on each side, a seat rail, in which the vehicle seat can be displaced and locked in the longitudinal vehicle direction; each of the seat rails being rigidly connected to the vehicle floor. The system of the present invention can be integrated relatively simply at the seat rails, by replacing the existing connecting elements between the seat assembly, including the seat cushion and seat back, and the seat rails on each side, with, in each instance, a hinged bearing and a rail piece. Then, in the case of such an example embodiment, a hinged bearing and a rail piece are positioned in each seat rail. In this case, the at least one hinged bearing can be situated behind or in front of the at least one rail piece with respect to a vehicle front end. If the hinged bearings are situated behind the rail pieces with respect to the vehicle front end, then the mounting elements move up in the guide opening at the front end of the seat, and the vehicle seat tilts back about the tilt axis situated at the rear end of the seat. If the hinged bearings are situated in front of the rail pieces with respect to the vehicle front end, then the mounting elements move down in the guide opening at the rear end of the seat, and the vehicle seat tilts back about the tilt axis situated at the front end of the seat; the tilting movement being assisted by the gravitational acceleration acting downwards.

In a further advantageous refinement of the pre-collision system, the guide opening can take the form of a slotted hole, which is inclined in the direction of the expected impact force. The maximum additional restraining path can be predetermined by the length of the slotted hole.

In a further advantageous refinement of the pre-collision system, the at least one rail piece can include a locking device that can retain the mounting element in the starting position during normal operation and can release it in response to a detected imminent collision. The locking device can be implemented, for example, as a narrowing of the guide opening running conically inwards. Using this example embodiment, the belt pressure generated by the belt tensioning function can be absorbed gently, as the mounting element deforms the narrowing, which runs conically inwards, during the transition from the starting position to the end position. Alternatively, the locking device can be implemented as a spring element that acts perpendicularly to the longitudinal extension of the guide opening. In this example embodiment, the mounting element can lock into the two positions in a stable manner, after the spring force is overcome. After activation, the seat can easily be pushed back again into the starting position. As a further alternative, the locking device can be constructed as a switchable detent, which frees or blocks the guide opening. In this manner, the pre-collision system can advantageously be prevented from being triggered unintentionally during normal vehicle operation. In addition, the different example embodiments of the locking device can be combined with each other.

Example embodiments of the present invention are depicted in the drawings and are explained in greater detail in the following description. In the drawings, identical reference characters denote components or elements that perform the same or analogous functions.

### BRIEF DESCRIPTION OF THE DRAWINGS

FIG. 1 is a schematic representation of a pre-collision system for an occupant protection system of a vehicle, where a vehicle seat is in a starting position, according to an example embodiment of the present invention.

FIG. 2 is a schematic representation of the pre-collision system where he vehicle seat is in an end position, according to an example embodiment of the present invention.

FIG. 3 is a schematic representation of a pre-collision system for an occupant protection system of a vehicle, where the vehicle seat is in the end position, according to another example embodiment of the present invention.

FIG. 4 is a schematic representation of a rail piece for the pre-collision system of FIGS. 1-3, according to an example embodiment of the present invention.

FIG. 5 is a schematic representation of a rail piece for the pre-collision system of FIGS. 1-3, according to another example embodiment of the present invention.

FIG. 6 is a schematic representation of a rail piece for the pre-collision system of FIGS. 1-3, according to another example embodiment of the present invention.

FIG. 7 is a block diagram of an occupant protection system for a vehicle, according to an example embodiment of the present invention.

### DETAILED DESCRIPTION

As is apparent from FIGS. 1-7, the depicted example embodiments of a pre-collision system 7 of the present invention, for an occupant protection system 1 of a vehicle, each includes a predictive sensor system 40, a vehicle seat 20, an evaluation and control unit 60, and a restraint system 10. In this connection, evaluation and control unit 60 evaluates output signals of predictive sensor system 40 and activates a belt tensioning function GSF of restraint system 10 if the evaluation of the output signals indicates an imminent collision. In belt 12, belt tensioning function GSF generates a tensile force, which presses a corresponding occupant 3 into vehicle seat 20. A kinetic energy of occupant 3 resulting from belt tensioning function GSF releases a pre-trigger mechanism 30, 30A, which is integrated into a mounting 28 of vehicle seat 20, and enables a blocked degree of freedom of vehicle seat 20, so that the entire vehicle seat 20 tilts about a defined tilt axis in the direction of an expected impact force FA. In this connection, impact force FA is the force that acts upon the vehicle due to the collision and causes the vehicle to decelerate. In the frame of reference of the vehicle, an accelerated movement of occupant 3 is directed oppositely to this force FA.

For example, a pyrotechnic or electromotive or mechanical actuating system or a pressure reservoir can be used for belt tensioning function GSF.

As is further apparent from FIGS. 1-3, in the example embodiments depicted, the vehicle seat 20 situated behind a windshield 5 in the direction of travel includes, in each instance, a seat cushion 22, a seat back 24, a headrest 26, and a seat mounting 28. On the two sides of vehicle seat 20, seat mounting 28 has seat rails 28.1, which are rigidly connected to the vehicle floor, and of which one is visible. In the example embodiments depicted, the pre-trigger mechanism 30, 30A integrated in seat mounting 28 includes, in each instance, two hinged bearings 32, of which one is visible. At hinged bearings 32, vehicle seat 20 is supported so as to be able to tilt about the tilt axis. In addition, the pre-trigger mechanism 30, 30A in the depicted example embodiments includes, in each instance, two rail pieces 34, which have a guide opening 34.1, and of which one is visible. A mounting element 28.2 of vehicle seat 20 is guided in each of guide openings 34.1.

As is further apparent from FIGS. 1-3, in each instance, a hinged bearing 32 and a rail piece 34 are positioned in one of the seat rails 28.1 so as to be able to move longitudinally. Using seat rails 28.1, the vehicle seat can be moved and locked in the longitudinal direction of the vehicle.

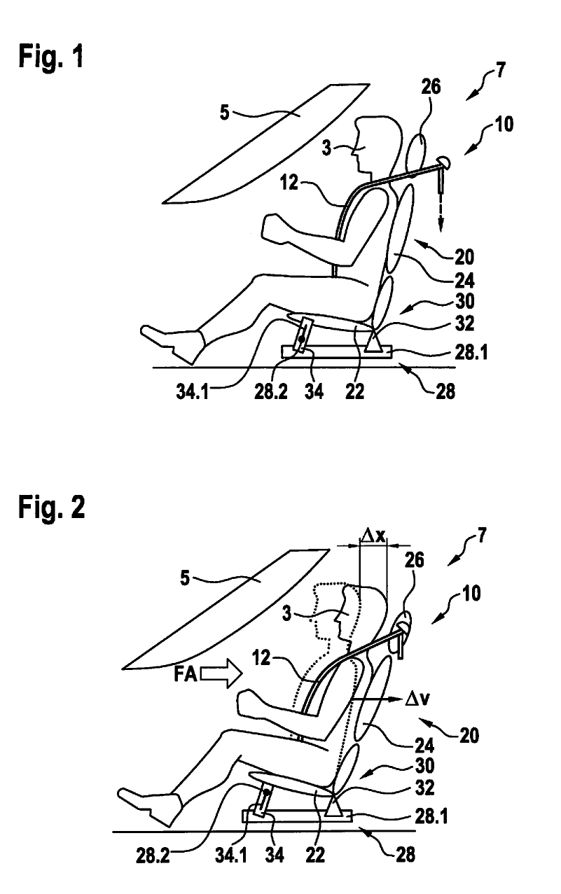

As is further apparent from FIGS. 1 and 2, the hinged bearings 32 in the first example embodiment depicted are situated in back of rail pieces 34 with respect to a vehicle front end. This means that hinged bearings 32 are situated at the rear end of the seat and rail pieces 34 are situated at the front end of the seat. In this manner, mounting elements 28.2 move up in guide openings 34.1 at the front end of the seat, and vehicle seat 20 tilts back about the tilt axis situated at the rear end of the seat.

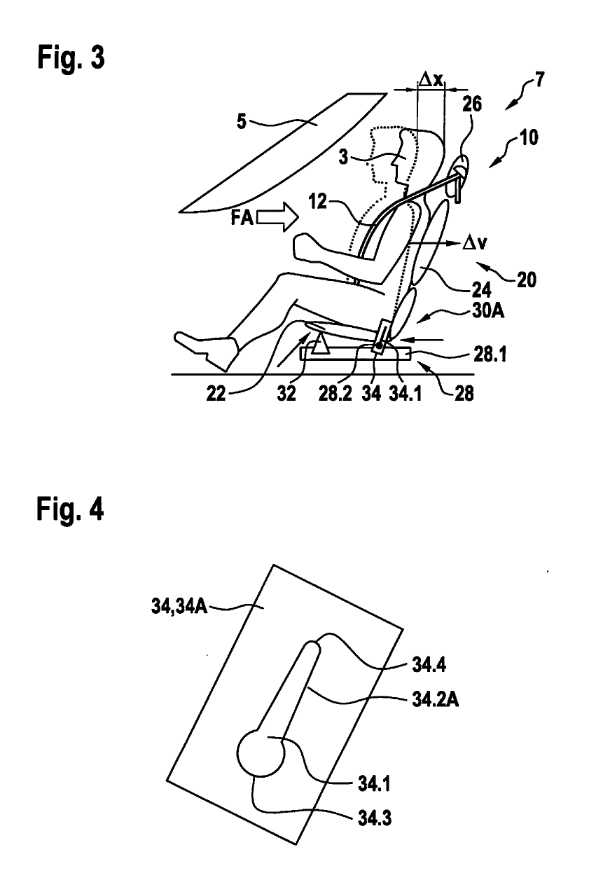

As is further apparent from FIG. 3, the hinged bearings 32 in the second example embodiment depicted are situated in front of rail pieces 34 with respect to a vehicle front end. This means that hinged bearings 32 are situated at the front end of the seat, and rail pieces 34 are situated at the rear end of the seat. In this manner, mounting elements 28.2 move down in guide opening 34.1 at the rear end of the seat, and vehicle seat 20 tilts back about the tilt axis situated at the front end of the seat; the tilting movement of vehicle seat 20 being assisted by the gravitational acceleration acting downwards.

In the case of a head-on collision, the kinetic energy of occupant 3 is reduced on an available restraining path, the so-called “ride down space.” Excluding pre-collision system 7 of the present invention, a restraining force F_{R1} acting upon occupant 3 is yielded from the law of conservation of energy, in accordance with equation (1).

$${F}_{R 1} = \frac{{m}_{I} * {v}_{I \_ abs}^{2}}{2 * {s}_{R}} \qquad ( 1 )$$

In this case, m_{I} represents a mass, v_{I}_{_}_{abs} represents an absolute velocity of occupant 3, and s_{R} represents an available deceleration path.

Using example embodiments of the pre-collision system 7 according to the present invention, it is possible to successfully give occupant 3 a preliminary impulse prior to the effect of the impact, so that restraining force F_{R2} is reduced during the deceleration event in accordance with equation (2).

$${F}_{R 2} = \frac{{m}_{I} * {( {v}_{I \_ abs} - Δ v )}^{2}}{2 * ( {s}_{R} + Δ x )} \qquad ( 2 )$$

In this case, Av represents a displacement velocity, and Ax represents an additional displacement path. As is further apparent from FIGS. 2 and 3, using the example embodiments of pre-collision system 7 according to the present invention, both the available restraining path s_{R} is increased by additional displacement path Δx, and the absolute velocity v_{I}_{_}_{abs} of occupant 3 is reduced by displacement velocity Δv. In this manner, the kinetic energy of occupant 3 is also reduced.

As is apparent from FIGS. 4-6, in each of the depicted example embodiments of rail piece 34, 34A, 34B, 34C, guide opening 34.1 is constructed as a slotted hole, which is formed between a starting position 34.3 and an end position 34.4. As is further apparent from FIGS. 1-3, the guide opening 34.1 taking the form of a slotted hole is inclined in the direction of expected impact force FA. In addition, in the example embodiments depicted, rail pieces 34, 34A, 34B, 34C include locking devices 34.2, which retain mounting element 28.2 in starting position 34.3 during normal operation and release it in response to a detected, imminent collision.

As is further apparent from FIG. 4, the locking device 34.2 in the depicted example embodiment is constructed as a narrowing 34.2A of guide opening 34.1 running conically inwards. Since mounting element 28.2 deforms the narrowing 34.2A running conically inwards, during the transition from starting position 34.3 to end position 34.4, the belt pressure generated by belt tensioning function GSF can be absorbed gently.

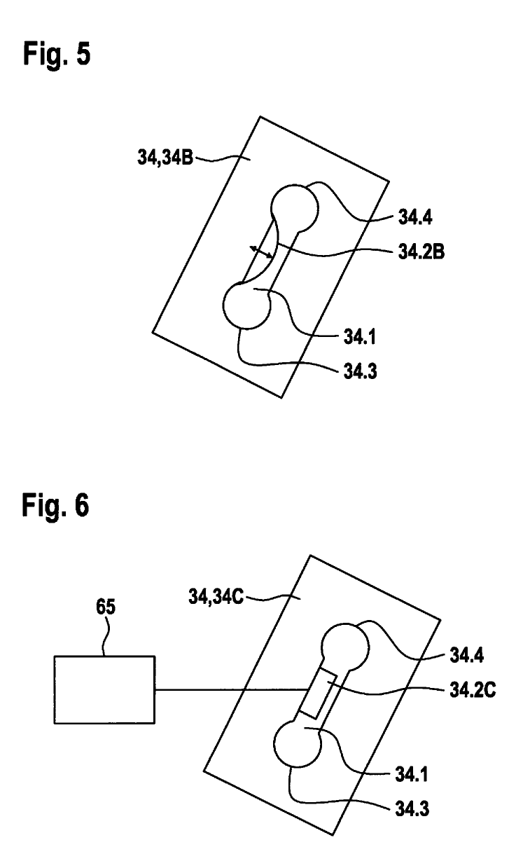

As is further apparent from FIG. 5, the locking device 34.2 in the depicted example embodiment is implemented as a spring element 34.2B, which acts perpendicularly to the longitudinal extension of guide opening 34.1. In this manner, after the spring force is overcome, mounting element 28.2 can lock into place in a stable manner in both starting position 34.3 and end position 34.4. In addition, after activation, vehicle seat 20 can easily be pushed back again into starting position 34.3.

As is further apparent from FIG. 6, the locking device 34.2 in the depicted example embodiment is constructed as a switchable detent 34.2C, which frees or blocks guide opening 34.1. In this manner, pre-collision system 7 can advantageously be prevented from being unintentionally triggered during normal vehicle operation. Switchable detent 34.2C can be actuated, for example, by a solenoid or pyrotechnically, in order to free guide opening 34.1 for moving mounting element 28.2.

In addition, the different example embodiments 34.2A, 34.2B, 34.2C of locking device 34.2 can be combined with each other.

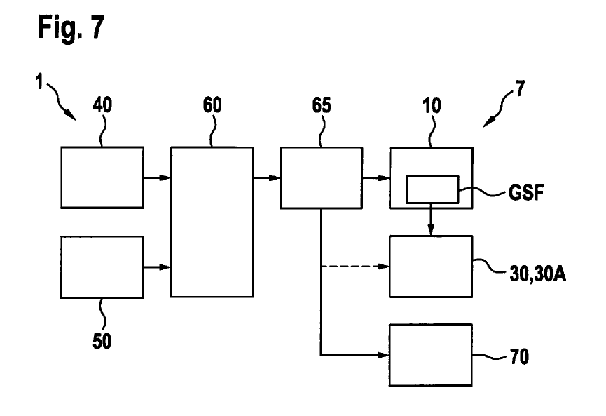

As is apparent from FIG. 7, the depicted example embodiment of an occupant protection system 1 for a vehicle includes the above-described, pre-collision system 7 having predictive sensor system 40, vehicle seat 20, evaluation and control unit 60, restraint system 10, pre-trigger mechanism 30, 30A, a contact sensor system 50, a driver block 65, and further restraining devices 70, such as various airbags, etc. Evaluation and control unit 60 evaluates output signals of predictive sensor system 40 and of contact sensor system 50 and, as a function of the evaluation, activates belt tensioning function GSF of restraint system 10, switchable detent 34.2C of pre-trigger mechanism 30, 30A, and/or further restraining devices 70, via driver block 65.

Example embodiments of the present invention can advantageously be integrated in the functional landscape and architecture of personal protection systems in a motor vehicle and combined with other occupant protection functions. The decision to use the belt tensioning function is advantageously not made independently of other functions, such as pre-crash positioning, which brings an occupant into an advantageous position prior to a collision, or individual occupant sensing, which determines the current position of the individual occupants, but is made in a coordinated manner.

1-10. (canceled)

11. An occupant protection system of a vehicle, the system comprising:
a predictive sensor system;
a vehicle seat;
a mounting on which the vehicle seat is mounted and that includes a tilt trigger;
a belt corresponding to the seat; and
a processor, wherein the processor is configured to:
evaluate output signals of the predictive sensor system;
determine based on the evaluation that a collision is imminent; and
responsive to the determination of the imminent collision, activate a belt tensioning function that generates in the belt a tensile force that presses an occupant into the seat and results in a kinetic energy of the occupant that causes the tilt trigger to enable the seat to tilt about a defined tilt axis in a direction of an expected impact force of the collision.

12. The system of claim 11, wherein the tilt trigger includes at least one hinged bearing on which the vehicle seat is supported so as to be tiltable about the tilt axis.

13. The system of claim 11, wherein the tilt trigger includes at least one rail in which there is a guide opening in which a mount of the seat is guidable between a starting position during a normal operation and an end position into which the mount is guided in response to the kinetic energy.

14. The system of claim 13, wherein:
the at least one hinged bearing and the at least one rail are positioned longitudinally movably in the mounting; and
the at least one hinged bearing is situated behind or in front of the at least one rail with respect to a front end of the vehicle.

15. The system of claim 13, wherein the guide opening is a slotted hole that extends upwards with an inclination in the direction of the expected impact force.

16. The system of claim 13, wherein the at least one rail includes a lock that retains the mount in the starting position during normal operation and releases the mount in response to the kinetic energy.

17. The system of claim 16, wherein the lock is constructed as a conical narrowing of the guide opening.

18. The system of claim 16, wherein the lock is constructed as a spring element that is arranged to act perpendicularly to a longitudinal extension of the guide opening.

19. The system of claim 16, wherein the lock is a switchable detent that is arranged to, at different times, free and block the guide opening.

20. An occupant protection device of a vehicle, the device comprising:
a processor that is configured to:
evaluate output signals of a predictive sensor system;
determine based on the evaluation that a collision is imminent; and
responsive to the determination of the imminent collision, activate a belt tensioning function that generates in a belt of a vehicle seat a tensile force that presses an occupant into the seat and results in a kinetic energy of the occupant that causes a tilt trigger to enable the seat to tilt about a defined tilt axis in a direction of an expected impact force of the collision.
